(19) United States
(12) Patent Application Publication
(10) Pub. No.: US 2026/0172542 A1
(43) Pub. Date: Jun. 18, 2026

(54) DISPLAY SYSTEM, DISPLAY METHOD, AND RECORDING MEDIUM

(71) Applicant: RICOH COMPANY, LTD., Tokyo (JP)

(72) Inventors: Kenichiroh SAISHO, Tokyo (JP); Sho NAGAI, Kanagawa (JP); Naoki MOTOHASHI, Kanagawa (JP); Yuuki SUZUKI, Kanagawa (JP)

(73) Assignee: Ricoh Company, Ltd., Tokyo (JP)

(21) Appl. No.: 19/119,946

(22) PCT Filed: Nov. 28, 2023
(86) PCT No.: PCT/IB2023/061948

§ 371 Date: Apr. 10, 2025

(30) Foreign Application Priority Data
Nov. 30, 2022 (JP) 2022-192007

(51) Int. Cl. H04N 13/398; G06T 15/04; G06T 17/30; H04N 13/271; H04N 13/275

(52) U.S. Cl. CPC H04N 13/398; G06T 15/04; G06T 17/30; H04N 13/271; H04N 13/275

(57) ABSTRACT

A display system, includes: a three-dimensional display controller to cause a display device to display an image of a three-dimensional reconstruction result representing a space, based on at least one of color information of the space and depth information of the space; a reception unit to receive first operations on the three-dimensional reconstruction result; a storage unit to store a history of the first operations received at the reception unit; a learning unit to learn the history of the first operations stored in the storage unit to generate a learning result; and an inference unit to output data that is newly generated based on a second operation newly received at the reception unit and the learning result of the learning unit, and the three-dimensional display controller is causes the display device to display the data that is output.

### TECHNICAL FIELD

The present disclosure relates to a display system, a display method, and a recording medium.

### BACKGROUND ART

Currently, “three-dimensional (3D) reconstruction” has been actively used, for example, at a construction site. In the 3D reconstruction, 3D information representing a 3D space, which is a physical space, is acquired by a laser scanner or a light detection and ranging (LiDAR) sensor, and reproduced on a digital space. The result of such 3D reconstruction is not only applicable to measurement of a specific object at the construction site, but also applicable to various types of use at sites other than the construction site, as the 3D reconstruction result can be associated with various types of information. As a specific example, a service is known, which improves the operability of a database storing the 3D reconstruction result by associating, for example, in addition to position information, various types of attribute information or photographs with the 3D reconstruction result.

PTL 1 discloses a technique for extracting an object to be collated with 3D model data from point cloud data including depth information, collating the extracted object with the 3D model data, and specifying a portion of the 3D model data that is collated with the object by machine learning. The above-described technique specifies the location of a target in a building, based on the information on the portion collated with the object in the 3D data, and the depth information of the point cloud data.

### CITATION LIST

### Patent Literature

PTL 1

Japanese Patent No. 7113611

### SUMMARY OF INVENTION

### Technical Problem

Typically, the application of 3D reconstruction has been limited only to use by experts, as the maintenance of 3D information that is acquired requires expertise and work, thus, discouraging use by the general user. Specifically, the person in charge of the 3D reconstruction system needed to perform some tasks of informing others of the current state. Such tasks include, for example, understanding geometric difference between the current state and the existing state as well as their semantic connections, counting quantities, and summarizing, all requiring work in data maintenance and learning. In other words, there was no system that can increase efficiency.

### Solution to Problem

Example embodiments include a display system, including: a three-dimensional display controller configured to cause a display device to display an image of a three-dimensional reconstruction result representing a space, based on at least one of color information of the space and depth information of the space; a reception unit configured to receive first operations on the three-dimensional reconstruction result; a storage unit configured to store a history of the first operations received at the reception unit; a learning unit configured to learn the history of the first operations stored in the storage unit to generate a learning result; and an inference unit configured to output data that is newly generated based on a second operation newly received at the reception unit and the learning result of the learning unit, and the three-dimensional display controller causes the display device to display the data that is output. Example embodiments include a display method, including: displaying, on a display, an image of a three-dimensional reconstruction result representing a space, based on at least one of color information of the space and depth information of the space; receiving first operations on the three-dimensional reconstruction result; storing, in a memory a history of the first operations received; learning the history of the first operations stored in the memory to generate a learning result; inferring data to be output, the data being newly generated based on a second operation newly received at the reception unit and the learning result of the learning unit; and displaying the data.

Example embodiments include a recording medium storing a program code for causing a computer system to carry out the display method.

### Advantageous Effects of Invention

According to at least one embodiment, a system is provided, which is automatically made customized to a user, through learning operations of the user. In utilizing spatial information based on 3D reconstruction, such system can reduce work of the user in data maintenance or learning, such that the user can easily use the system.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a block diagram illustrating a configuration of a display system according to an exemplary embodiment.

FIG. 2 is a block diagram illustrating a configuration of various functions of a controller of the display system of FIG. 1.

FIG. 3 is a diagram illustrating functional blocks related to bounding box processing, performed by the display system of FIG. 1, according to a first example.

FIG. 4 is an illustration of an example 3D reconstruction result displayed in the bounding box processing according to the first example.

FIG. 5 is a diagram illustrating functional blocks related to automatic modeling, performed by the display system of FIG. 1, according to a second example.

FIG. 6 is an illustration of an example 3D reconstruction result displayed in the automatic modeling according to the second example.

FIG. 7 is a diagram illustrating functional blocks related to processing to determine whether to carry in a specific object, performed by the display system of FIG. 1, according to a third example.

FIG. 8 is an illustration of an example 3D reconstruction result displayed in the processing to determine whether to carry in the specific object, according to the third example.

FIG. 9 is a diagram illustrating functional blocks related to automatic family processing, performed by the display system of FIG. 1, according to a fourth example.

FIG. 10 is a diagram illustrating functional blocks related to automatic counting according to a fifth example.

FIG. 11 is an illustration of an example 3D reconstruction result displayed in the automatic counting according to the fifth example.

FIG. 12 is a diagram illustrating functional blocks related to automatic tour processing, performed by the display system of FIG. 1, according to a sixth example.

FIG. 13 is an illustration of an example 3D reconstruction result displayed in the automatic tour processing according to the sixth example.

FIG. 14 is a diagram illustrating functional blocks related to automatic measuring, performed by the display system of FIG. 1, according to a seventh example.

FIG. 15 is an illustration of an example 3D reconstruction result displayed in the automatic measuring according to the seventh example.

FIG. 16 is a diagram illustrating functional blocks related to text processing, performed by the display system of FIG. 1, according to an eighth example.

FIG. 17 is an illustration of an example 3D reconstruction result displayed in the automatic modeling, according to the eighth example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a display system, a display method, and a program for controlling display are described in detail below, with reference to the accompanying drawings.

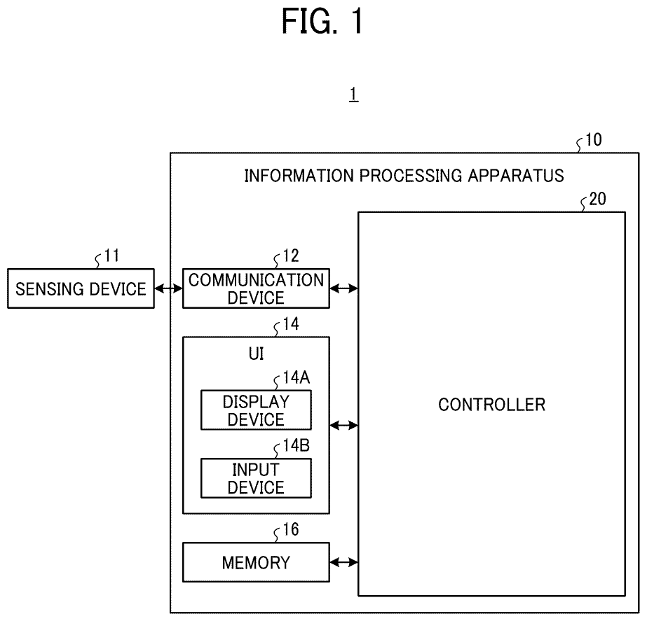

FIG. 1 is a block diagram illustrating a configuration of a display system 1 according to an embodiment.

As illustrated in FIG. 1, the display system 1 includes an information processing apparatus 10 and a sensing device 11. The information processing apparatus 10 and the sensing device 11 are communicably connected with each other.

The sensing device 11 obtains three-dimensional (3D) information on a 3D space, which is a physical space. In this disclosure, the 3D information is any information that may be necessary to generate a 3D reconstruction result. Examples of the 3D information include, but not limited to, an image (for example, a two-dimensional image of the 3D space) and depth information of the 3D space. The sensing device 11 is, for example, a general-purpose optical camera, a spherical camera, a laser scanner, a time-of-flight (ToF) camera, or a stereo camera. In the ToF method, an object to be measured is irradiated with infrared light, and the distance to an object to be measured is calculated from a time it takes from the emission of infrared light to the object until for a light reflected from the object is returned. The stereo camera, with two cameras, obtains depth information as distance information, based on the distance between the two cameras and parallax information of images respectively obtained by the two cameras. The sensing device 11 is mounted on, for example, a vehicle or a drone.

The sensing device 11 may be any device that obtains 3D information (image and depth information), such as a system that obtains 3D information using LiDAR or photogrammetry. Alternatively, the sensing device 11 may be a smartphone with a laser scanner or a LiDAR sensor.

The 3D information represents a 3D space, which is a physical space. Any file format may be used for the 3D information. The 3D information (image and depth information) is, for example, shape data representing a 3D shape of a 3D object in the physical space. The 3D information (image and depth information) is, for example, a data file in point cloud format that represents a 3D space by discrete points, or a data file in polygon mesh format representing a 3D space by vertices and surfaces. The data file in point cloud format may be referred to as, for example, a depth map or a distance image.

The data file in point cloud format may be represented by an extension such as “.xyz”, “.e57”, and “.ply”. The data file in polygon mesh format may be represented by an extension such as “.obj”, “.fbx”, and “.stl”.

The sensing device 11 outputs the obtained 3D information (image and depth information) to the information processing apparatus 10.

The information processing apparatus 10 displays an image, which is obtained by viewing a 3D space represented by the 3D information (an image and depth information) from a virtual viewpoint of a virtual camera. The information processing apparatus 10 is, for example, a smartphone, a tablet terminal, or a personal computer. The image to be displayed may be a two-dimensional image or a 3D image.

The information processing apparatus 10 includes a communication device 12, a user interface (UI) 14 that partly serves as a reception unit, a memory 16 that serves as a storage unit, and a controller 20. The communication device 12, the UI 14, the memory 16, and the controller 20 are communicably connected to one another.

The communication device 12 communicates with an external information processing apparatus via a network, for example. The communication device 12 may be implemented by a network interface circuit. In this embodiment illustrated in FIG. 1, the communication device 12 communicates with the sensing device 11.

The UI 14 includes a display device 14A and an input device 14B. The display device 14A is, for example, a display that displays various types of information, such as a liquid crystal display (LCD). The input device 14B receives an operation instruction from a user, such that it serves as the reception unit.

The input device 14B is, for example, a keyboard, or a pointing device such as a mouse.

The display device 14A and the input device 14B may be combined into a single device, such as a touch panel.

The memory 16 stores various types of information.

The controller 20 executes information processing according to various types of software programs previously installed. The controller 20 is, for example, a central processing circuit (CPU) as described below. Such programs are previously stored in the memory 16 for execution by the controller 20.

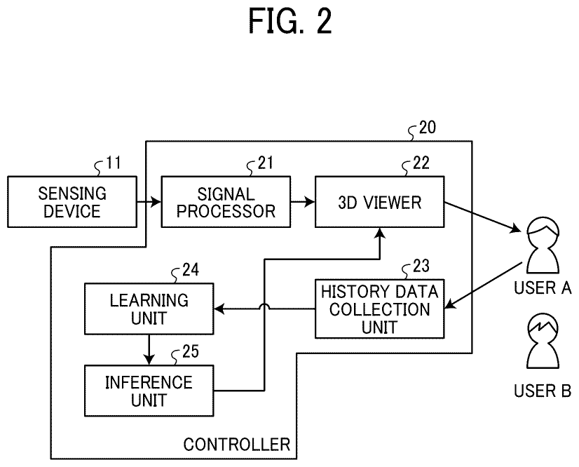

Various functions performed by the controller 20 are described below, according to the embodiment. FIG. 2 is a block diagram illustrating a functional configuration of the controller 20 for describing various functions of the controller 20.

In this embodiment, the controller 20 includes a signal processor 21, a 3D viewer 22 as a 3D display controller, a history data collection unit 23, a learning unit 24, and an inference unit 25.

The signal processor 21, the 3D viewer 22, the history data collection unit 23, the learning unit 24, and the inference unit 25 are each implemented by, for example, one or more processors. For example, any of the above-described units may be implemented by causing a processor such as the CPU to execute a program, which is software. Alternatively, any of the above-described units may be implemented by a processor such as a dedicated Integrated Circuit (IC), which is hardware.

Alternatively, any of the above-described units may be implemented by using software and hardware in combination. When multiple processors are used, each processor may implement one of the above-described units or two or more of the above-described units.

The signal processor 21 outputs the 3D information (image and depth information) acquired by the sensing device 11. Based on the 3D information, a 3D reconstruction result is generated for display via the 3D viewer 22. In this embodiment, the signal processor 21 acquires the 3D information (image and depth information) from the sensing device 11 via the communication device 12. The signal processor 21 may acquire the 3D information (image and depth information) from another information processing apparatus communicably connected to the information processing apparatus 10 via the communication device 12 and a network. The other information processing apparatus is, for example, a smartphone that acquires the 3D information (image and depth information), but is not limited to the smartphone. The signal processor 21 may acquire the 3D information from the memory 16.

The 3D information acquired by the signal processor 21 may contain monochrome information or color information of the 3D space. In a case where the 3D information contains color information, the information processing apparatus 10 converts the 3D information (image and depth information) into a 2D image using the color information, and displays the 2D image. Accordingly, the 2D color image is provided to the user, which is more visually perceptible to the user.

The signal processor 21 outputs the 3D information (image and depth information) that is acquired to the 3D viewer 22. The signal processor 21 converts the 3D information (image and depth information) acquired from the sensing device 11 to have a particular data format, and outputs the 3D information in the particular data format to the 3D viewer 22. For example, the signal processor 21 may convert a data file of the 3D information in a point cloud format into a data file of the 3D information in a polygon mesh format, using any desired method, and output the 3D information (image and depth information) having the converted format to the 3D viewer 22. The processing of converting a file format may be performed by the 3D viewer 22.

The signal processor 21 may perform other types of processing including, for example, alignment of different types of images captured at different locations (registration calibration), noise removal, meshing, texture-mapping, and retopology.

The 3D viewer 22 receives an instruction from a user A via the input device 14B. Further, the 3D viewer 22, which operates as a display control unit, enables visual recognition of three dimensionally arranged data by changing the viewpoint, walking through, or immersion. In the present embodiment, the 3D viewer 22 controls display on the display device 14A. The 3D viewer 22 operates, for example, on a smartphone, a tablet terminal, or a personal computer (PC). The 3D viewer 22 may cause visual stimuli to continuously respond to a touch or dragging by a mouse, or may provide the user (for example, the user A) with an immersive experience through a virtual reality device (head-mounted display), for example. In other words, the 3D viewer 22 serves as a user interface, which interacts with the user.

In example operation, the user A browses the 3D reconstruction result of a site through the 3D viewer 22, to recognize a space represented by the 3D reconstruction result. At this time, the user A performs operation (example of first operation) on the 3D viewer 22 in various ways depending on the purpose of browsing. Examples of the first operation by the user include viewpoint transition in the 3D reconstruction result, zooming in or out of a target, addition of a comment, introduction to another user, measurement, association with another database, addition of attribute information, and editing of existing information.

The history data collection unit 23 extracts a history of the above-described first operations of the user as data, and accumulates such data in the memory 16 or on a cloud server connected via the network as history data of the user A in the 3D reconstruction space.

The learning unit 24 inputs history data collected not only from the user A but also from a large number of stakeholders (users). The learning unit 24 generates a model by machine learning using the input history data or an operation result as train data. The learning unit 24 may further receive information regarding the attributes of the user, which are registered in association with the user, and learn the information on the attributes of the user. Although there are various types of machine learning, a model based on deep learning is preferable as learning is performed on a wide range of data such as image, depth, and natural language.

In one example, the inference unit 25 outputs particular metadata based on the model generated by the learning unit 24 to the 3D viewer 22 in accordance with browsing or input by another user B, different from the user A. The operation such as browsing or input by the other user B is an example of second operation. In the present embodiment, metadata refers not to the 3D reconstruction data, but to data newly generated based on a relationship between the 3D reconstruction data and history data related to use of the 3D reconstruction data. The user B recognizes the metadata in a visually perceptible form. For example, the metadata may be overlayed on a screen display by the 3D viewer 22. At the same time when the user B views the metadata, the history data collection unit 23 collects such operation as history data of the user B to be learned by the learning unit 24. In such case, the operation of the user B is an example of the first operation.

While the example illustrated in FIG. 2 is viewed by the user B, in another example, the user A may view the metadata output from the inference unit 25, at a time different from the time when the user A previously viewed the 3D reconstruction result.

In the processing of learning by the learning unit 24, in response to reception of the first operation by the UI 14 serving as the reception unit, first processing is performed according to the first operation. In the processing of utilizing a learning result, in response to reception of the second operation by a user, processing based on the first processing is performed according to a result of the inference unit 25, irrespective of the second operation by the user.

The information processing apparatus 10 of FIGS. 1 and 2 outputs data, which is newly generated based on a result of learning user operations with respect to a 3D reconstruction result. Various example applications of the information processing apparatus 10 of FIGS. 1 and 2 are described below.

### First Example

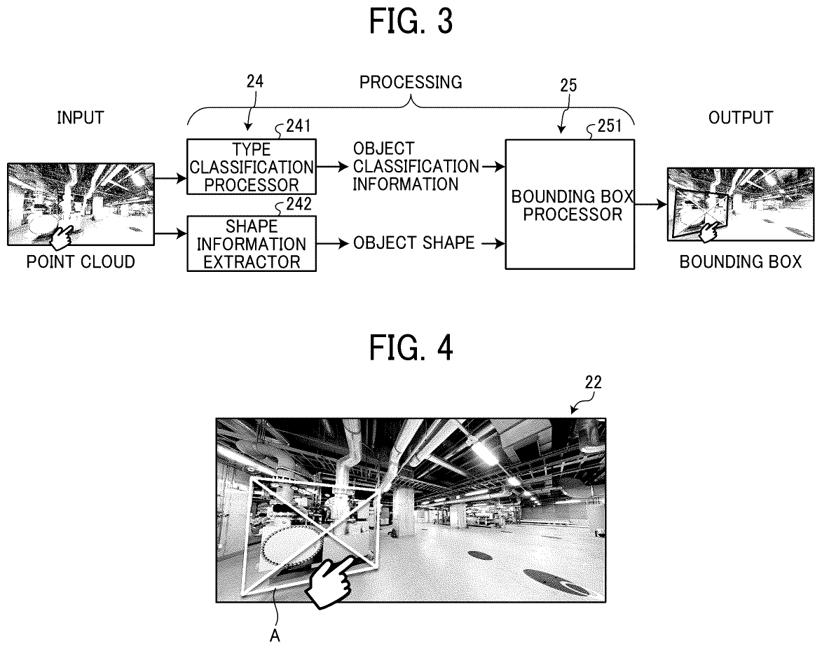

FIG. 3 is a diagram illustrating functional blocks related to bounding box processing according to a first example. The example illustrated in FIG. 3 is one example of processing related to a bounding box. The bounding box is a rectangular sub-region that encompasses an object of interest, by enclosing a region having the object of interest, with respect to an external area, by the minimum rectangle. FIG. 4 illustrates an example of the bounding box, as a white rectangle.

In the first example, it is assumed that a user selects a part (subset) of a 3D reconstruction result by operating the 3D viewer 22, as a subset to be designated with a bounding box.

The learning unit 24 learns the subset (object) of the 3D reconstruction result indicated by the bounding box, which is designated through the operation (first operation) of the 3D viewer 22 by the user.

The inference unit 25 infers a subset (object) of a 3D reconstruction result to be newly displayed by the 3D viewer 22 using a bounding box. Such subset of the 3D reconstruction result is a subset of data to which the bounding box is to be designated.

More specifically, as illustrated in FIG. 3, the learning unit 24 includes a type classification processor 241 and a shape information extractor 242. The inference unit 25 includes a bounding box processor 251.

The type classification processor 241 executes segmentation, which is a task of segmenting an image of the 3D reconstruction result into a plurality of objects by machine learning. The type classification processor 241 executes learning processing, to recognize an object to which a bounding box is designated through an operation (first operation) of the 3D viewer 22 by the user. The type classification processor 241 outputs object classification information for identifying the object that is recognized, to the bounding box processor 251.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) to which the bounding box is designated through the operation (first operation) of the 3D viewer 22 by the user, as the primitive shape fitting is being executed. The shape information extractor 242 outputs the object shape that is detected, to the bounding box processor 251.

The bounding box processor 251 infers a subset (object) of a 3D reconstruction result to be newly displayed by the 3D viewer 22, to which the bounding box is to be designated, based on the object classification information output from the type classification processor 241 and the object shape output from the shape information extractor 242.

FIG. 4 is an illustration of an example 3D reconstruction result displayed in the above-described bounding box processing. In the example illustrated in FIG. 4, the 3D viewer 22 displays a subset of data representing a specific object in a room, which is surrounded by a bounding box A in advance.

As described above, the subset (object) to which the bounding box is to be designated is inferred and newly displayed on the 3D viewer 22. Since the subset (object) to which the bounding box is designated is automatically selected, the user can easily select or refer to the subset to which the bounding box is designated. Thus, the information processing apparatus 10 assists the user in conveying information more efficiently.

The first example illustrates an example case in which the user operates the 3D viewer 22 to designate the bounding box. Additionally or alternatively, any other type of object may be designated to the subset of the 3D reconstruction result, such as comments or marks.

### Second Example

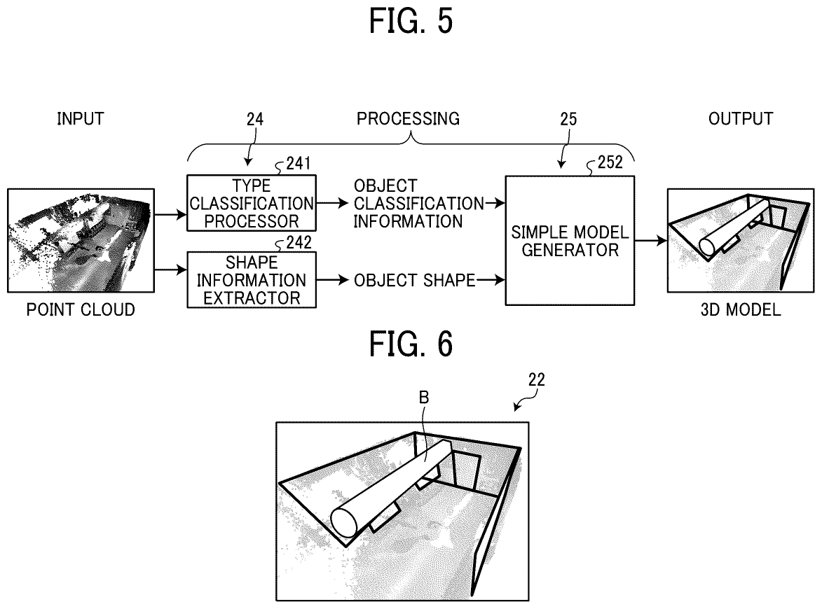

FIG. 5 is a diagram illustrating functional blocks related to automatic modeling according to a second example. The example illustrated in FIG. 5 is one example of processing related to automatic modeling.

In the second example, it is assumed that a user operates the 3D viewer 22 to select and trace a part (subset) of a 3D reconstruction result to create a new 3D model. The 3D model is model data created as 3D solid data.

The learning unit 24 uses the new 3D model as train data, and learns a relationship between the new 3D model and the subset (object) of the 3D reconstruction result.

The inference unit 25 infers a 3D model to be generated from a subset (object) of the 3D reconstruction result, which is selected by the user.

More specifically, as illustrated in FIG. 5, the learning unit 24 includes a type classification processor 241 and a shape information extractor 242. The inference unit 25 includes a simple model generator 252.

The type classification processor 241 executes segmentation, which is a task of segmenting an image of a 3D reconstruction result into a plurality of objects by machine learning. The type classification processor 241 executes learning processing, to recognize a 3D model newly generated by the user through an operation (first operation) of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) newly generated by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

FIG. 6 is an illustration of an example 3D reconstruction result displayed in the automatic modeling. In the example illustrated in FIG. 6, the 3D viewer 22 displays a subset of data representing a specific object in a room, which is converted into a 3D model B.

As described above, the 3D viewer 22 infers and displays the 3D model, to be newly created by the user. For example, if a subset of data representing a specific object in a room is replaced with a 3D model, the user can move or edit the 3D model in the 3D reconstruction space. For example, the user may freely move the subset (object) in the room, for example, to consider delivery (for example, carrying in) of the object or a new design of the object.

### Third Example

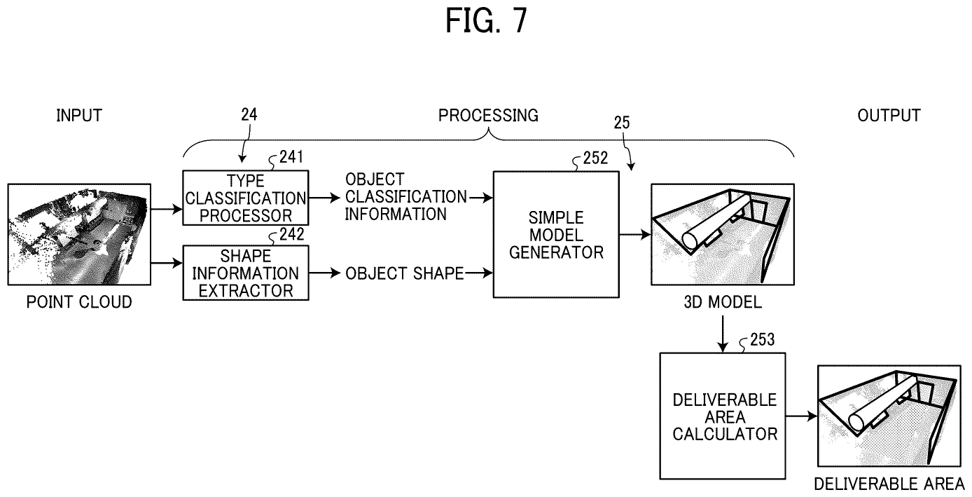

FIG. 7 is a diagram illustrating functional blocks related to processing to determine whether to carry in a specific object, according to a third example. The example illustrated in FIG. 7 is one example of processing to determine whether to carry in a specific object.

In the third example, it is assumed that a user inputs a 3D model into the 3D reconstruction result, and determines whether or not to carry in a specific object to a space represented by the 3D reconstruction result. The 3D model is model data created as 3D solid data.

The learning unit 24 receives the 3D model as an input, and receives data indicating a bottleneck in delivery (such as a projection and a step) in the 3D reconstruction result as train data, and learns a relationship between a modified 3D model and a determination result indicating whether to carry in for the existing 3D model.

The inference unit 25 infers a place with a potential risk (an area where an interference or a collision is likely to occur), when a specific object is carried in or out, using the 3D model.

Alternatively, the inference unit 25 may infer a deliverable area, by mapping a range where the specific object can be carried in or out in the 3D reconstruction result.

More specifically, as illustrated in FIG. 7, the learning unit 24 includes a type classification processor 241 and a shape information extractor 242. The inference unit 25 includes a simple model generator 252 and a deliverable area calculator 253.

The type classification processor 241 executes segmentation, which is a task of segmenting an image into a plurality of objects by machine learning. The type classification processor 241 executes learning processing, to recognize a 3D model input to the 3D reconstruction result by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) input to the 3D reconstruction result by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

The deliverable area calculator 253 infers a place with a potential risk (an area where an interference or a collision is likely to occur), when a specific object is carried in or out. The specific object in the present example corresponds to the 3D model converted by the simple model generator 252. Alternatively, the inference unit 25 may infer a deliverable area of the 3D model by mapping a range where the specific object, which is represented by the 3D model, can be carried in or out.

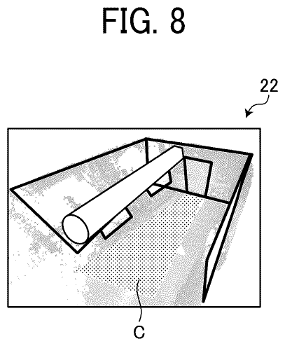

FIG. 8 is an illustration of an example 3D reconstruction result displayed in the processing to determine whether to carry in the specific object. In the example illustrated in FIG. 8, the 3D viewer 22 displays a subset of data representing a specific object in a room, which is converted into a 3D model, and a deliverable area C of the specific object represented by the 3D model.

As described above, the 3D viewer 22 infers and displays the 3D model, input to the 3D reconstruction result by the user, with an indication of the deliverable area of the 3D model. The inference unit 25 assists the user by semi-automatically planning a delivery route, thus, informing the delivery route to the user or any other stakeholder. In other words, the inference unit 25 assists the user or any other stakeholder (user) in planning a delivery route, by automatically proposing a possible delivery route.

As a modification to the example of FIG. 8, the learning unit 24 may not only learn whether or not to deliver, but also a result of confirming safety. In such case, the learning unit 24 may output a risk that an accident may occur, as metadata, based on the 3D reconstruction result. This results in automation or increased efficiency of activities to manage site safety.

### Fourth Example

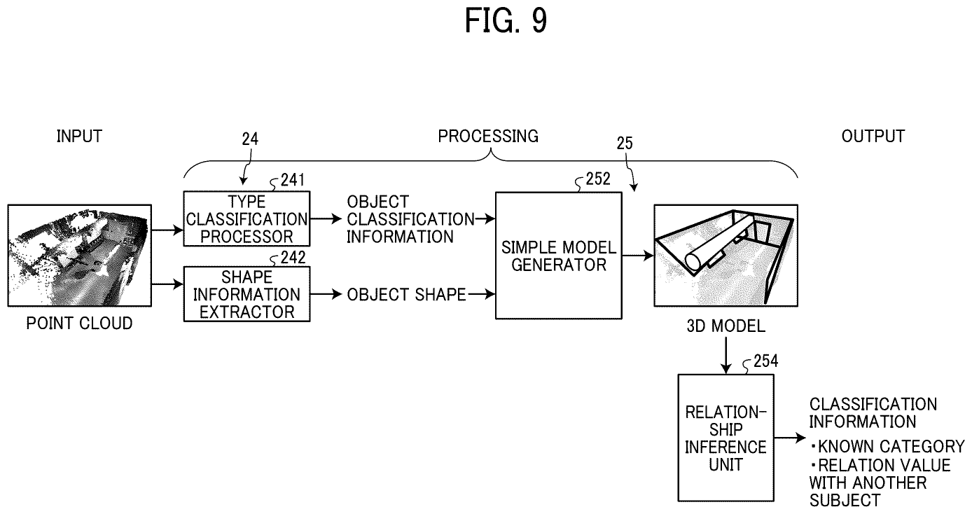

FIG. 9 is a diagram illustrating functional blocks related to automatic family processing according to a fourth example. The example illustrated in FIG. 9 is one example of processing related to automatic family processing.

In the fourth example, it is assumed that a user selects a subset (object) of the 3D reconstruction result, and enters attribute information (for example, a manufacturer, and a manufacturing year) to be designated to the subset. More specifically, the user places, for example, a “machine” as a new model in the 3D reconstruction space, and enters attribute information for such new model.

The learning unit 24 is input with a subset (object) of the 3D reconstruction result that is selected, and learns a relationship between the attribute information for the selected subset (object) and the existing structured data as train data.

The inference unit 25 infers an attribute to be designated to a structure of the existing structured data, for the subset (object) of the 3D reconstruction result that is selected.

More specifically, as illustrated in FIG. 9, the learning unit 24 includes a type classification processor 241 and a shape information extractor 242. The inference unit 25 includes a simple model generator 252 and a relationship inference unit 254.

The type classification processor 241 executes segmentation, which is a task of segmenting an image into a plurality of objects by machine learning. The type classification processor 241 executes learning processing, to recognize a 3D model input to the 3D reconstruction result by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) input to the 3D reconstruction result by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

The relationship inference unit 254 infers a relationship between the 3D model, which is placed in the 3D reconstruction space as a new model (for example, a machine) and converted by the simple model generator 252, and another existing member, based on the geometric shape and the attribute information that is input.

The relationship inference unit 254 outputs attribute information including a relation value of the 3D model with the existing category and another subject.

As described above, the 3D viewer 22 displays the attribute information including the relation value of the 3D model with the existing category and the other subject. This allows updating of data in the 3D reconstruction space, while maintaining the relationship with a structure of the existing structured data. With updating of a space, a database is also updated. Accordingly, a family structure is kept stored for use in other 3D CAD and BIM tools.

### Fifth Example

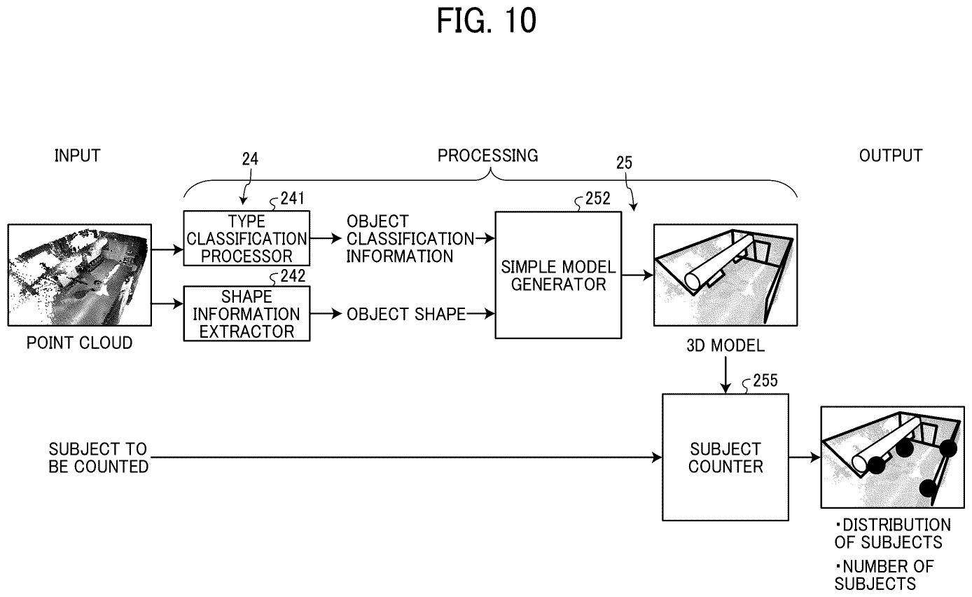

FIG. 10 is a diagram illustrating functional blocks related to automatic counting according to a fifth example. The example illustrated in FIG. 10 is one example of processing related to automatic counting.

In the fifth example, it is assumed that a user selects a subset of a 3D reconstruction result by operating the 3D viewer 22, and counts a number of objects in the selected subset to input the counted number of objects.

The learning unit 24 is input with a subset of the 3D reconstruction result, and learns a relationship between the subject of the 3D reconstruction result and the number of objects input by the user as train data.

The inference unit 25 infers a number of objects, such as a quantity of articles, in a subset of a 3D reconstruction result that is selected by a user.

More specifically, as illustrated in FIG. 10, the learning unit 24 includes a type classification processor 241 and a shape information extractor 242. The inference unit 25 includes a simple model generator 252 and a subject counter 255.

The type classification processor 241 executes segmentation, which is a task of segmenting an image into a plurality of objects by machine learning. The type classification processor 241 executes learning processing, to recognize a 3D model newly generated by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) newly generated by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

The subject counter 255 infers a quantity of articles with respect to a subset in the 3D reconstruction result that is selected.

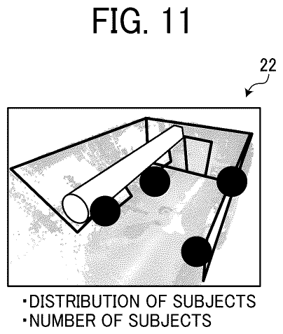

FIG. 11 is an illustration of an example 3D reconstruction result displayed in the automatic counting. The example of FIG. 11 illustrates a distribution of subjects and a number of the subjects, of the subset in the room that is selected.

The above-described example may be applied not only to extract quantity, but also to extract a value related to geometry such as an area or a volume. Further, a the function of inferring the quantity of each of a plurality of articles included in the subset may be provided, if the types of objects to be counted are learned in addition to the quantity. Similarly, if the association with a name (natural language) of each object is learned in addition to the quantity, the subject counter 255 answers “3” to an input of a text “stepladder”, for example.

### Sixth Example

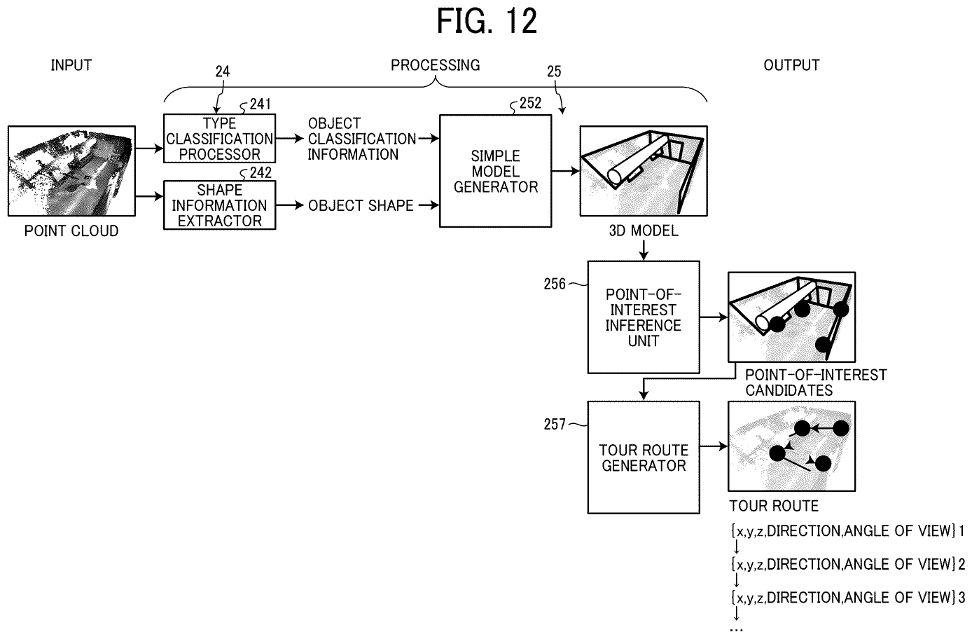

FIG. 12 is a diagram illustrating functional blocks related to automatic tour processing according to a sixth example. The example illustrated in FIG. 12 is one example of processing related to automatic tour processing.

In the sixth example, it is assumed that a user performs operation, such as viewpoint transition in the 3D reconstruction result, zooming in or out of a target, addition of a comment, introduction to another user, measurement, association with another database, addition of attribute information, and editing of existing information. After such operation, the user notifies the stakeholder (user) of a plurality of points of interest.

The learning unit 24 is input with the 3D reconstruction result, and accumulated logs of user activities indicating a sequence of points-of-interest as train data, to learn a relation between the 3D reconstruction result and the points-of-interest. The “sequence of points-of-interest” is indicated by, for example, a viewpoint, an angle of view, given information, and a time-series order of the sequence of points-of-interest having been selected by the user from the 3D restoration result.

In response to an input of a new 3D reconstruction result, the inference unit 25 infers candidates of sequence of points-of-interest.

More specifically, as illustrated in FIG. 12, the learning unit 24 includes a type classification processor 241 and a shape information extractor 242. The inference unit 25 includes a point-of-interest inference unit 256 and a tour route generator 257.

The type classification processor 241 executes segmentation, which is a task of segmenting an image into a plurality of objects by machine learning. The type classification processor 241 executes learning processing, to recognize a 3D model newly generated by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) newly generated by the user through the operation of the 3D viewer 22, as the primitive shape fitting is being executed. The shape information extractor 242 outputs the object shape that is detected to the point-of-interest inference unit 256.

In response to an input of a new 3D reconstruction result, the point-of-interest inference unit 256 infers candidates of sequence of points-of-interest, as candidates of point-of-interest.

The tour route generator 257 proposes a candidate of tour route based on the candidates of point-of-interest inferred by the point-of-interest inference unit 256.

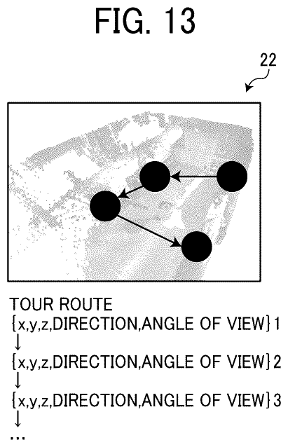

FIG. 13 is an illustration of an example 3D reconstruction result displayed in the automatic tour processing. FIG. 13 illustrates an example tour route for checking a machine room, displayed by the 3D viewer 22. The inference unit 25 proposes a candidate of tour route, based on a result of learning the past tour routes for another place. Using the proposed tour route, the user goes around in the 3D reconstruction result, to carry out various types of activities such as inspection, investigation, or inputting comments. The log of such activities by the user at the time of tour are accumulated and learned by the learning unit 24 as “know-how and tacit knowledge in relation to the tour”.

The learning unit 24 may also learn attributes of the user to be reflected on the learning model. With such learning model, the inference unit 25 can infer, based on not only a 3D reconstruction result and a sequence of points-of-interest, but also a user attribute and a purpose of tour.

The inference unit 25 may be further provided with a function of enabling fine editing of the inferred sequence of points-of-interest by subsequent user interaction, or a function of outputting a document in a format desired by the user.

### Seventh Example

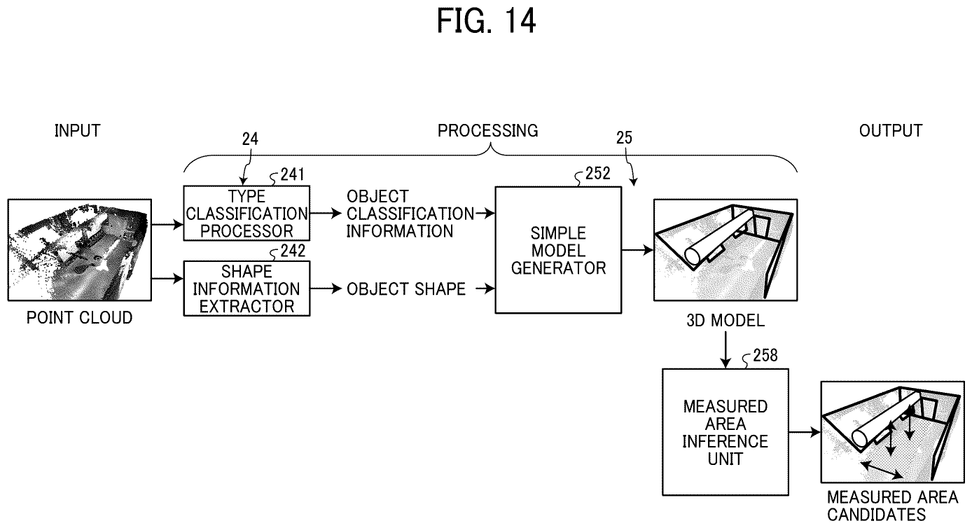

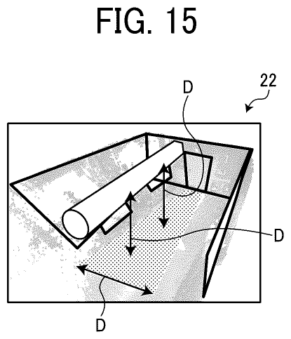

FIG. 14 is a diagram illustrating functional blocks related to automatic measuring according to a seventh example. The example illustrated in FIG. 14 is one example of processing related to automatic measuring.

In the seventh example, it is assumed that a user adds a measurement result to a 3D reconstruction result, in order to recognize an empty space, when a new structure or a scaffold is brought in at a site before a renewal work.

The learning unit 24 learns a relationship of the measured area with the 3D reconstruction result using the measured area as train data. The measured area is defined as a line, a plane, or a solid formed by two or more points extracted from the 3D reconstruction result.

The inference unit 25 infers and proposes a “location to be measured around the object”, when the user turns his or her viewpoint toward the object to be investigated or when the user hovers a mouse on the 3D viewer 22.

More specifically, as illustrated in FIG. 14, the learning unit 24 includes a type classification processor 241 and a shape information extractor 242. The inference unit 25 includes a simple model generator 252 and a measured area inference unit 258.

The type classification processor 241 executes segmentation, which is a task of segmenting an image into a plurality of objects by machine learning. The type classification processor 241 executes learning processing, to recognize a 3D model newly generated by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) newly generated by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

The measured area inference unit 258 infers and proposes a “location to be measured around the object”, when the user turns his or her viewpoint toward the object to be investigated or when the user hovers a mouse on the 3D viewer 22.

The user selects or accepts a candidate of measurement area displayed on the 3D viewer 22 by the inference unit 25, to output a measurement result to the 3D reconstruction result, as a result of measurement made by the user.

FIG. 15 is an illustration of an example 3D reconstruction result displayed in the automatic measuring. FIG. 15 illustrates an example case in which the inference unit 25, which has learned measurement results obtained at similar sites, proposes a candidate of measurement (measurement candidate D) for a new 3D reconstruction result. In particular, in the vicinity of a ceiling where equipment is present, objects such as a column and a prism are likely to intersect vertically with each other, and measurement is often performed in a direction of the column and prism. If an investigator has less experience, it may be difficult to perform measurement in the shortest time period, while ensuring measurement of areas necessary for investigation. In this example, with assistance of the inference unit 25, the investigator can refer to information regarding such areas necessary for investigation.

The learning unit 24 may also learn attributes of the user to be reflected on the learning model. With such learning model, the inference unit 25 can infer, based on not only a 3D reconstruction result and measured areas, but also a user attribute and a purpose of measurement. Further, the learning unit 24 may use the measurement result as original data, which is to be converted to material data in a specific format.

### Eighth Example

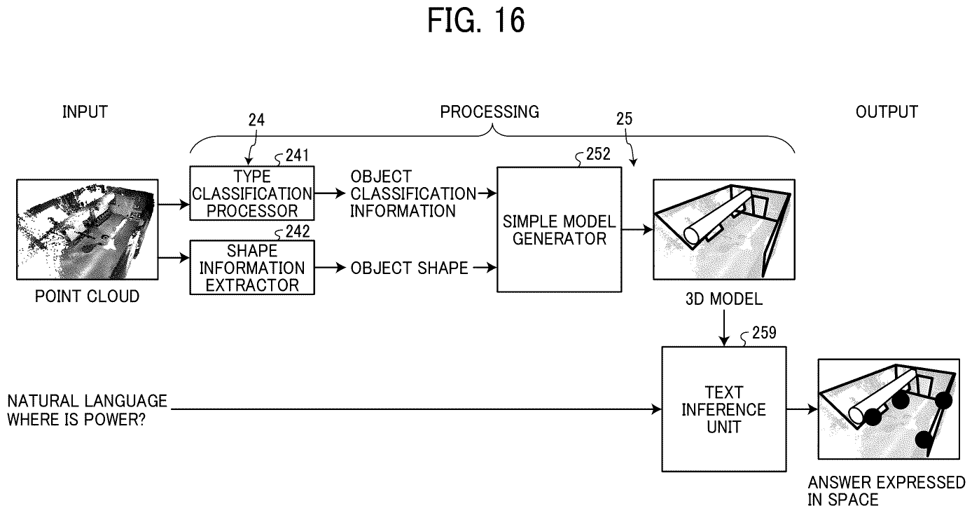

FIG. 16 is a diagram illustrating functional blocks related to text processing according to an eighth example. The example illustrated in FIG. 16 is one example of processing related to automatic counting.

In the eighth example, it is assumed that a user gives comments in natural language to a 3D reconstruction result with attribute information. Preferably, the 3D reconstruction result is accompanied with attribute information.

The learning unit 24 learns a relationship between the 3D reconstruction result and a natural language corresponding to the 3D reconstruction result, based on accumulated comments by the user in natural language.

The inference unit 25 responds to the comments in natural language or questions input by the user, in the form of mapping to the 3D reconstruction result, a natural language, or a list.

More specifically, as illustrated in FIG. 16, the learning unit 24 includes a type classification processor 241 and a shape information extractor 242. The inference unit 25 includes a simple model generator 252 and a text inference unit 259.

The type classification processor 241 executes segmentation, which is a task of segmenting an image into a plurality of objects by machine learning. The type classification processor 241 executes learning processing, to recognize a 3D model newly generated by the user through an operation of the 3D viewer 22. The type classification processor 241 outputs object classification information for identifying the 3D model that is recognized to the simple model generator 252.

The shape information extractor 242 performs primitive-shape fitting, which fits simple geometric shape (primitive shape) such as a cube, a cylinder, or an ellipse to a set of 3D points as a 3D reconstruction result. The shape information extractor 242 executes learning processing, which detects a shape of the object (object shape) newly generated by the user through the operation of the 3D viewer 22, as the primitive shape fitting is being executed. The shape information extractor 242 outputs the object shape that is detected to the simple model generator 252.

The simple model generator 252 converts a subset (object) of a 3D reconstruction result to be newly displayed by the 3D viewer 22, to a 3D model, based on the object classification information output from the type classification processor 241 and the object shape output from the shape information extractor 242.

The text inference unit 259 responds to the comments in natural language or questions input by the user, in the form of mapping to the 3D reconstruction result, a natural language, or a list.

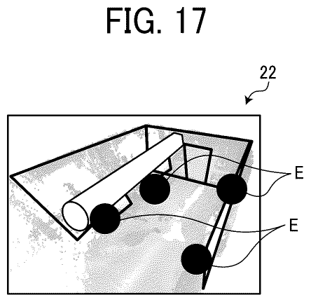

FIG. 17 is an illustration of an example 3D reconstruction result displayed in the automatic modeling. FIG. 17 illustrates an example screen displayed by the 3D viewer 22 based on a response of the inference unit 25 to the comments in natural language input by the user, in the form of mapping on the 3D reconstruction result or natural language. Specifically, in FIG. 17, the inference unit 25 indicates subsets E of the 3D reconstruction result each matching a name in natural language “Where is the power source?”.

Similarly, in a case where a new name “2022” in natural language is added to the name “Where is the power source?”, the inference unit 25 may cause one or more subsets E of the 3D reconstruction result, which have been manufactured in 2022, to pop out. Using the above-described functions, the user can “experience” the 3D reconstruction result representing a current status, in a manner such that “space” and “language” are linked with each other, so that the user can recognize the space more accurately.

According to the present embodiment using the one or more examples, the learning unit 24 learns a 3D reconstruction result, and an association between operation for executing specific processing, and a result of such processing. Based on the learning, the inference unit 25 infers processing to be performed on the 3D reconstruction result. Further, the learning unit 24 learns a 3D reconstruction result, and an association between attributes of a user who views the 3D reconstruction result and actions of the user. Based on the learning, the inference unit 25 infers an intention of the user in using the 3D reconstruction result. Through learning operations of the user, the above-described system can automatically be made customized for the user. In utilizing spatial information based on 3D reconstruction, such system can reduce work of the user in data maintenance or learning. This system can also allow the general user to easily use the system. For example, when the user performs operation, such as browsing, extraction, or addition of information to the 3D reconstruction result representing a specific site, the system assists the user in providing tacit knowledge (knowledge based on experience or intuition, for example) of a skilled person.

Any computer program executed by the above-described information processing apparatus 10 according to the one or more examples of the embodiment described above may be provided, in a file format installable to or executable by a computer, as a computer program product stored in a computer-readable recording medium, such as a compact disc read only memory (CD-ROM), a flexible disk (FD), a compact disc recordable (CD-R), and a digital versatile disk (DVD).

Alternatively, any computer program executed by the information processing apparatus 10 according the one or more examples of the embodiment described above may be stored in a computer connected to a network such as the Internet and downloaded through the network. Alternatively, any computer program executed by the information processing apparatus 10 according to the one or more examples of the embodiment described above may be provided or distributed via a network such as the Internet.

Although some embodiments of the present disclosure and modifications thereof have been described above, the above-described embodiments are not intended to limit the scope of the present disclosure. Such embodiments and modifications may be modified into a variety of other forms. Various omissions, substitutions, and changes in the above-described embodiments and modifications may be made without departing from the spirit of the present disclosure. Such embodiments and modifications are within the scope and gist of this disclosure and are also within the scope of appended claims and the equivalent scope.

The machine learning is a technique for causing a computer to acquire human-like learning capability, and refers to a technique in which a computer autonomously generates an algorithm necessary for determination of data identification or the like from learning data acquired in advance, and applies the algorithm to new data to perform prediction. Any suitable learning method is applied for machine learning, for example, any one of supervised learning, unsupervised learning, semi-supervised learning, reinforcement learning, and deep learning, or a combination of two or more those learning.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2022-192007, filed on Nov. 30, 2022, in the Japan Patent Office, the entire disclosure of which is hereby incorporated by reference herein.

### REFERENCE SIGNS LIST

1 Display system
14 Reception unit (14B)
16 Storage unit
22 Three-dimensional display controller
24 Learning unit
25 Inference unit

1. A display system, comprising:
a storage device; and
processing circuitry configured to,
cause a display device to display an image of a three-dimensional reconstruction result representing a space; based on at least one of color information of the space and depth information of the space,
receive first operations on the three-dimensional reconstruction result,
store a history of the first operations in the storage device,
generate a learning result by learning the history of the first operations stored in the storage device; and
infer output data that is newly generated based on a newly received second operation and the learning result, and
cause the display device to display the output data.

2. The display system of claim 1, wherein the processing circuitry is further configured to:
learn, as the history of the first operations, a subset of the three-dimensional reconstruction result indicated by a bounding box designated by a user;
infer a subject of a newly-generated three-dimensional reconstruction result based on the bounding box; and
output the newly-generated three-dimensional reconstruction result as the output data.

3. The display system of claim 1, wherein the processing circuitry is further configured to:
learn, using a three-dimensional model created from a subset of the three-dimensional reconstruction result as train data, a relationship between the three-dimensional model and the subset of the three-dimensional reconstruction result; and
infer a new three-dimensional model to be generated based on a subset of the three-dimensional reconstruction result selected by a user as the output data.

4. The display system of claim 1, wherein the processing circuitry is further configured to:
learn, using a three-dimensional model as an input and data indicating a bottleneck in delivery of the three-dimensional model in the three-dimensional reconstruction result as train data, a new three-dimensional model and a determination result indicating whether to deliver the new three-dimensional model in the three-dimensional reconstruction result; and
infer, in a case that an object is delivered in or out based on the new three-dimensional model of the object, a place with a potential risk, or a deliverable area of the object by mapping.

5. The display system of claim 1, wherein the processing circuitry is further configured to:
learn, using a subset of the three-dimensional reconstruction result that is selected as an input and a relationship between attribute information for the selected subset and existing structured data, as train data; and
infer an attribute to be designated to a structure of the existing structured data, for the subset of the three-dimensional reconstruction result that is selected.

6. The display system of claim 1, wherein the processing circuitry is further configured to:
learn, using a subset of the three-dimensional reconstruction result as an input and a number of objects input by a user, as train data; and
infer a number of objects in the subset of a three-dimensional reconstruction result that is selected.

7. The display system of claim 1, wherein the processing circuitry is further configured to:
learn, using the three-dimensional reconstruction result as an input and accumulated log of activities indicating a sequence of points-of-interest of a user as train data, a relationship between the three-dimensional reconstruction result and the accumulated log of activities, the sequence of points-of-interest being indicated by a viewpoint, an angle of view, given information, and a time-series order of the sequence of points-of-interest; and
in response to an input of a new three-dimensional reconstruction result, infer one or more candidates of sequence of points-of-interest.

8. The display system of claim 1, wherein the processing circuitry is further configured to:
learn, using a measured area of the three-dimensional reconstruction result as train data, a relationship between the measured area and the three-dimensional reconstruction result, the measured area being defined as a line, a plane, or a solid formed by two or more points extracted from the three-dimensional reconstruction result; and
infer a location to be measured, in response to the second operation being a user operation, the user operation including at least one of:
changing a viewpoint of a user toward an object to be investigated, an operation of the user with the three-dimensional display controller, or a combination thereof.

9. The display system of claim 1, wherein the processing circuitry is further configured to:
learn a relationship between the three-dimensional reconstruction result and a natural language corresponding to the three-dimensional reconstruction result, based on accumulated comments by a user using the natural language; and
respond to a natural language input by the user, in the form of mapping to the three-dimensional reconstruction result, a natural language, or a list.

10. A display method, comprising:
displaying, on a display, an image of a three-dimensional reconstruction result representing a space based on at least one of color information of the space and depth information of the space;
receiving first operations on the three-dimensional reconstruction result;
storing, in a memory device, a history of the received first operations;
generating a learning result by learning the history of the first operations stored in the memory device;
inferring output data, the output data being newly generated based on a newly received second operation and the learning result; and
displaying the output data on the display.

11. A non-transitory computer recording medium storing program code for causing a computer system to carry out a display method, the display method comprising:
displaying, on a display, an image of a three-dimensional reconstruction result representing a space based on at least one of color information of the space and depth information of the space;
receiving first operations on the three-dimensional reconstruction result;
storing, in a memory device, a history of the first operations;
generating a learning results by learning the history of the first operations stored in the memory device;
inferring output data, the output data being newly generated based on a newly received second operation newly and the learning result; and
displaying the output data on the display.
